(19) United States
(12) Patent Application Publication
(10) Pub. No.: US 2025/0065694 A1
(43) Pub. Date: Feb. 27, 2025

(54) AIR VENT FOR VEHICLE

(71) Applicant: HYUNDAI MOBIS CO., LTD., Seoul (KR)

(72) Inventor: Seong Cheon CHO, Yongin-si (KR)

(73) Assignee: HYUNDAI MOBIS CO., LTD., Seoul (KR)

(21) Appl. No.: 18/511,245

(22) Filed: Nov. 16, 2023

(30) Foreign Application Priority Data
Aug. 23, 2023 (KR) 10-2023-0110610

(51) Int. Cl. B60H 1/34

(52) U.S. Cl. CPC B60H 1/3421; B60H 2001/3471

(57) ABSTRACT

A vehicle air vent including a duct housing, a first wing horizontally extending in a discharge port of the duct housing; a second wing vertically extending in the duct housing; and a driving link of having a first side connected to the first wing and a second side connected to the second wing. The driving link slides along a guide groove in a bottom surface of the duct housing in the discharge port to rotate the second wing in a left-right direction.

### CROSS-REFERENCE TO RELATED APPLICATION

This application claims priority to and the benefit of Korean Patent Application No. 10-2023-0110610, filed on Aug. 23, 2023, in the Korean Intellectual Property Office, the disclosure of which is incorporated herein by reference in its entirety for all purposes.

### BACKGROUND

### 1. Field of the Invention

The present invention relates to a vehicle air vent.

### 2. Discussion of Related Art

A vehicle includes an air conditioning apparatus for controlling an air temperature and ventilation in an interior. The air conditioning apparatus generates heat to keep the interior of the vehicle warm in the winter and generates cold air to keep the interior of the vehicle cool in the summer.

The air conditioning apparatus may include an air conditioning unit which controls the air temperature through heat exchange between air and a heat exchange medium and a blower unit which supplies air to the air conditioning unit. The vehicle may provide air-conditioned air into the interior of the vehicle through an air vent connected to the air conditioning unit. Such an air vent is disposed inside a dashboard, and a discharge port is exposed toward a passenger room through a hole formed in the dashboard.

Recently, due to a trend of slimming a cockpit module in the vehicle, slimming of the discharge port of the air vent has also been studied.

However, in the conventional air vent, since many components are used in the air vent to prevent loss of wind volume provided toward a passenger room while to slim a discharge port, there is a problem of increased manufacturing cost.

In particular, a front wing for controlling wind in a left-right direction is configured so that interference does not occur during the operation of a knob bar by cutting and removing an inner side of a portion connected to the knob bar of a wing knob. However, since the inner side of the front wing is cut excessively, there is a problem that performance to control the wind in the left-right direction is seriously reduced. In addition, since the inner side of the connected portion should be cut, a shape thereof is complicated, and thus there is a problem that the air vent is not easy to design and manufacture.

Therefore, it is necessary to solve the problems.

### SUMMARY OF THE INVENTION

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

The present invention is directed to providing a vehicle air vent improved so that a structure and operating mechanism for controlling a wind direction is simplified while a discharge port is slimed.

Objectives of the present invention are not limited to the above-described objectives, and other objectives which are not described above will be clearly understood to those skilled in the art from the following description.

In one general aspect, a vehicle air vent includes a duct housing, a first wing horizontally extending in a discharge port of the duct housing; a second wing vertically extending in the duct housing; and a driving link of having a first side connected to the first wing and a second side connected to the second wing. The driving link is configured to slide along a guide groove in a bottom surface of the duct housing in the discharge port to rotate the second wing in a left-right direction.

The driving link may include a first body extending from the first wing toward the bottom surface of the duct housing and a second body extending from the first body toward the second wing.

The first body may include a connecting pin extending horizontally along the first wing on an upper end of the first body and a guide protruding downward from a lower end of the first body, and the driving link may be configured to slide along the guide groove in a state in which the guide is inserted into the guide groove.

The second body may include a coupling hole coupled to a coupling protrusion of the second wing in an end of the second body.

The first wing may include a connecting groove into which the connecting pin is rotatably connected, and the connecting groove may be connected to an opening that is open downward from the first wing along an inclined surface inclined downward toward the second wing.

The vehicle air vent may further include a jog disposed outside the discharge port and coupled to the first wing to vertically rotate the first wing.

The vehicle air vent may further include a wing knob disposed on the discharge port and connected to the first wing to vertically rotate the first wing, wherein the wing knob includes an upper knob and a lower knob which surround the first wing, and in state in which the upper knob and the lower knob are coupled to each other, the upper knob and the lower knob may define an inner space of which both sides are open to allow the first wing to pass through the inner space.

The lower knob may include a through hole through which the first body passes and a support that protrudes from both sides of the through hole and in which the connecting pin is seated, and a seating groove to which the connecting pin is rotatably fitted may be disposed in the support.

The upper knob may include a pressing protrusion that protrudes toward the support to prevent the connecting pin from being separated from the seating groove.

The first wing may include an accommodation hole that accommodates the support in a state in which the first wing is disposed in the inner space.

Other features and aspects will be apparent from the following detailed description, the drawings, and the claims.

### BRIEF DESCRIPTION OF THE DRAWINGS

FIG. 1 is a view illustrating a vehicle air vent according to an embodiment of the present invention;

FIG. 2 is a schematic view illustrating a configuration of the vehicle air vent of FIG. 1;

FIG. 3 is a view showing a connection state between a second wing and a driving link;

FIG. 4 is a view showing a connection state between a first wing and the driving link;

FIG. 5 is a view showing a state in which the driving link is disposed between the first wing and a duct housing;

FIG. 6 is a view showing a state in which the first wing and the second wing are disposed in the duct housing;

FIG. 7 is a view illustrating a vehicle air vent according to another embodiment of the present invention;

FIG. 8 is a schematic view illustrating a configuration of the vehicle air vent of FIG. 7;

FIG. 9 is a set of views illustrating a lower knob of a wing knob;

FIG. 10 is a view illustrating an upper knob of the wing knob;

FIG. 11 is a view showing a connection state between the wing knob and a driving link; and

FIG. 12 is a view showing a connection state between a first wing and the wing knob.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION OF EXEMPLARY EMBODIMENTS

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Hereinafter, embodiments of the present invention will be described in detail with reference to the accompanying drawings, and components which are the same or correspond to each other will be denoted by the same or corresponding reference numerals in all drawings, and redundant descriptions will be omitted.

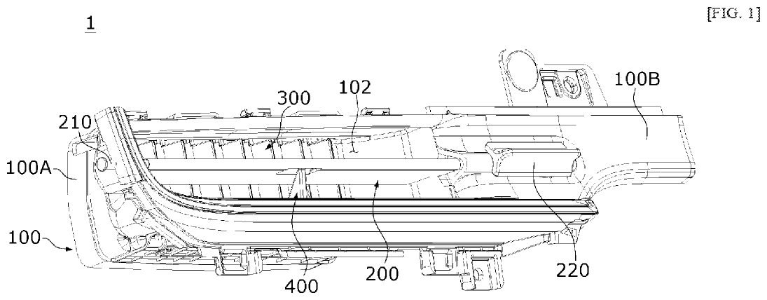

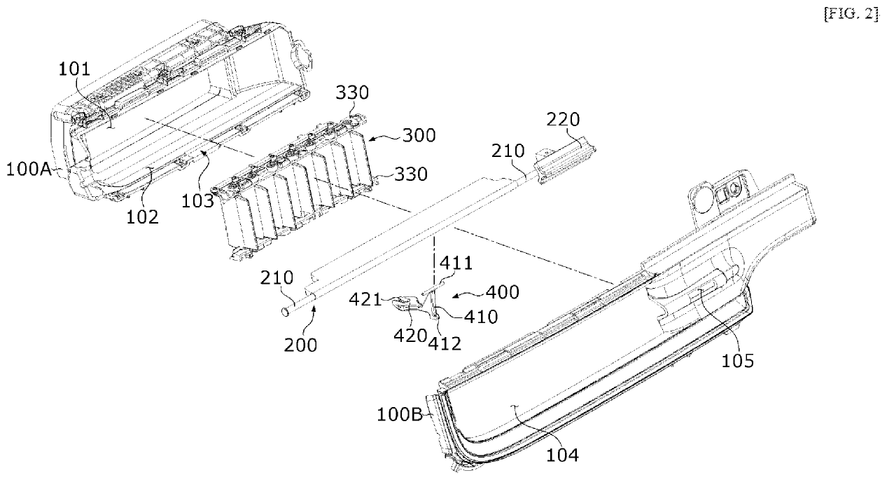

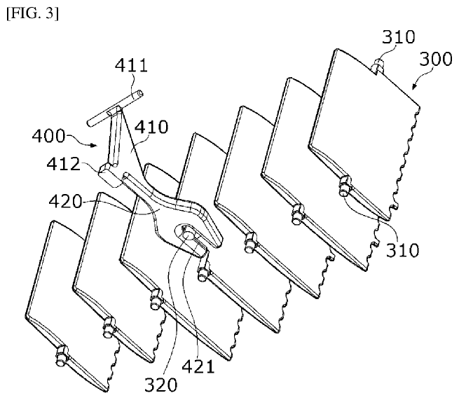

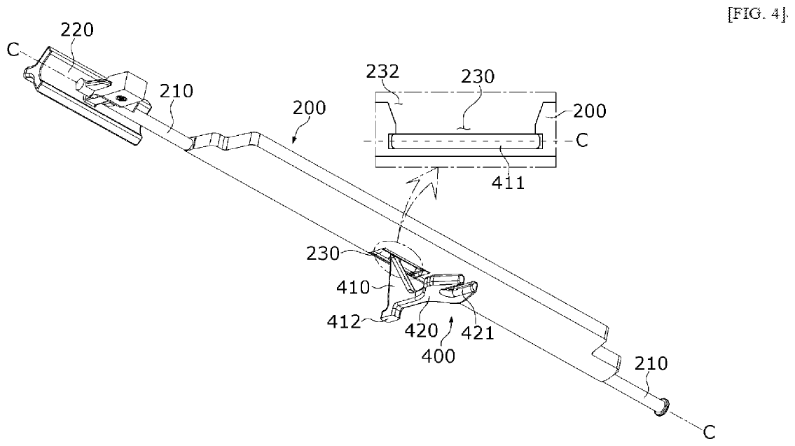

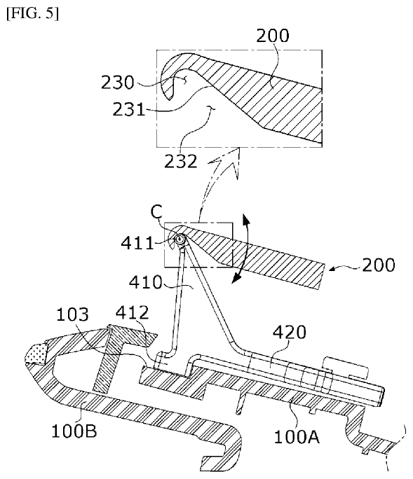

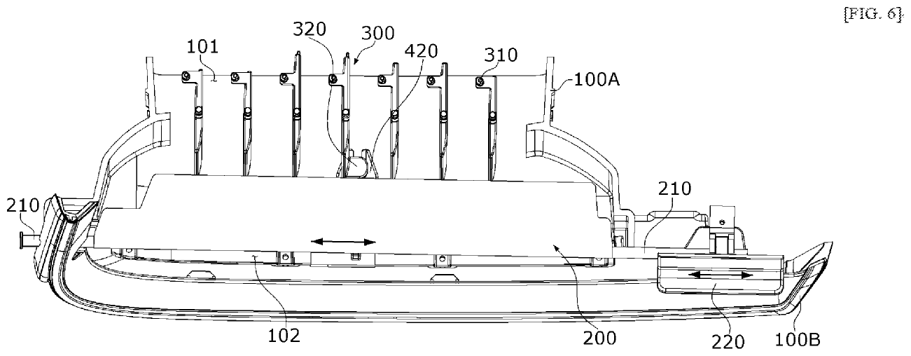

FIGS. 1 to 6 are views illustrating a vehicle air vent and a configuration thereof according to an embodiment of the present invention.

A vehicle air vent 1 according to the embodiment of the present invention is connected to an air conditioning apparatus (not shown) of a vehicle and may discharge air-conditioned air to a passenger room by adjusting a wind direction of the air-conditioned air.

Referring to the drawings, the vehicle air vent 1 according to the embodiment of the present invention may include a duct housing 100, a first wing 200, a second wing 300, and a driving link 400.

The duct housing 100 may guide air, which is air-conditioned by the air conditioning apparatus (not shown), to be discharged toward the passenger room.

The duct housing 100 may include a first duct body 100A and a second duct body 100B.

The first duct body 100A may have a substantially hollow quadrangular shape so that an inlet 101 through which air is introduced and a discharge port 102 through which air is discharged are formed.

The second duct body 100B may be coupled to the discharge port 102 of the first duct body 100A. The second duct body 100B may correspond to a portion exposed toward the passenger room in a dashboard and set a movement direction of air discharged through the discharge port 102 from an interior of the first duct body 100A.

The second duct body 100B may include a through hole 104 connected to the discharge port 102.

The first wing 200 may be disposed to horizontally extend in the discharge port 102 of the duct housing 100.

The first wing 200 may be installed in the duct housing 100 to be vertically rotated around a pair of rotary shafts 210.

Vertical rotational driving of the first wing 200 may be implemented using a jog 220 coupled to the rotary shafts 210 of the first wing 200.

The jog 220 may be disposed outside the discharge port 102 and provided to protrude toward the passenger room from a surface of the second duct body 100B. A control hole 105 through which the jog 220 passes through and to which the jog is coupled may be formed in the second duct body 100B.

The jog 220 may extend inward from the second duct body 100B and be coupled to the rotary shafts 210 of the first wing 200. Accordingly, a passenger may vertically manipulate the jog 220 to vertically rotate the first wing 200 in the discharge port 102, and horizontally operate the jog 220 to horizontally move the first wing 200 in the discharge port 102.

In such a jog-type structure, since a wing knob coupled to a perimeter of the first wing 200 in the discharge port 102 is omitted, air can be accurately discharged in a target direction. That is, since an air flow is not interfered with by the wing knob which partially blocks the discharge port 102, air can be discharged smoothly in a desired direction. In addition, a design of a slimmer structure can be implemented.

In addition, since only the first wing 200 is exposed toward the passenger room in the through hole 104, a simple design is implemented.

The second wing 300 may be disposed behind the first wing 200 and installed to be rotated in a left-right direction. A plurality of second wings 300 may be disposed in the duct housing 100 to extend longitudinally.

The second wing 300 may be coupled to a support block 330 disposed in the first duct body 100A to be rotated around a rotary shaft 310.

The second wing 300 disposed in a center of the plurality of second wings 300 may include a coupling protrusion 320. In the embodiment, the coupling protrusion 320 may be provided on a lower surface of the second wing 300.

The second wing 300 may be connected to the driving link 400, which will be described below, through the coupling protrusion 320.

In the present embodiment, all the plurality of second wings 300 may have the same shape and structure. In addition, the coupling protrusion 320 may be further provided on only the second wing 300 connected to the driving link 400. Such a configuration has an effect of improving an air direction control function compared to a structure in which an inner side of a second wing is excessively cut for connection with a wing knob in the conventional air vent. That is, the inner side of the conventional second wing is excessively cut to greatly degrade a basic horizontal wind direction control performance, however, in the present embodiment, since there is no such cutting, there is an effect of improving a horizontal wind direction control function. In addition, the cutting of the second wing can be omitted to simplify a shape of the second wing, and thus an effect of improving productivity can be obtained.

One side and the other side of the driving link 400 may be connected to the first wing 200 and the second wing 300, respectively.

The driving link 400 may be configured to slide in the left-right direction along a bottom surface of the duct housing 100 in the discharge port 102 to rotate the second wing 300 in the left-right direction.

As shown in the drawings, the driving link 400 may include a first body 410 extending from the first wing 200 toward the bottom surface of the duct housing 100 and a second body 420 extending from the first body 410 toward the second wing 300.

The first body 410 may include a connecting pin 411 having a substantially thin rod structure and horizontally extending along the first wing 200 on an upper end of the first body 410 and a guide 412 protruding downward on a lower end of the first body 410.

The second body 420 may have a thin plate structure horizontally disposed on the bottom surface of the duct housing 100 and include a coupling hole 421 into which the coupling protrusion 320 of the second wing 300 is inserted and coupled in an end of the second body 420. The coupling hole 421 may be formed in the form of a slot extending long toward the second wing 300, and thus the second body 420 may have a substantially pincer-shaped structure.

The driving link 400 is configured to slide along a guide groove 103 in a state in which the guide 412 is inserted into the guide groove 103 provided in the bottom surface of the duct housing 100. The guide groove 103 may be provided in a straight structure extending in the left-right direction along the first wing 200 from a lower portion of the discharge port 102.

The sliding of the driving link 400 may be implemented as the first wing 200 moves in the left-right direction in a state in which the connecting pin 411 provided on the upper end of the first body 410 is connected to the first wing 200.

Specifically, the first wing 200 may include a connecting groove 230 into which the connecting pin 411 of the first body 410 is rotatably connected.

The connecting groove 230 may be provided to extend long in a longitudinal direction of the first wing 200 in the first wing 200 and disposed along an axis C which is the same as that of the rotary shaft 210 of the first wing 200. Accordingly, the connecting pin 411 of the driving link 400 may be disposed along the axis C which is the same as that of the rotary shaft 210 of the first wing 200 in the connecting groove 230 and coupled to the connecting groove 230 in a state in which both side end portions of the connecting pin 411 are restricted in the connecting groove 230.

The connecting groove 230 may be connected to an opening 232 which is open downward from the first wing 200 along an inclined surface 231 inclined downward and backward toward the second wing 300. In addition, the connecting pin 411 may be inserted into the connecting groove 230 through the opening 232.

In a state in which the upper end of the first body 410 is inserted into and connected to the first wing 200 through the opening 232, the inclined surface 231 may be formed to be inclined with a gentle inclination with respect to a lower surface of the first wing 200 in order for the first wing 200 not to interfere with the first body 410 even when the first wing 200 vertically rotates around the rotary shaft 210. In addition, a surface of the first body 410 facing the inclined surface 231 may be inclined to correspond to the inclined surface 231.

As described above, in the driving link 400, the upper end of the first body 410 is rotatably connected into the connecting groove 230 of the first wing 200 through the connecting pin 411, and the lower end thereof is disposed in the discharge port 102 to be slidably connected to the guide groove 103 of the bottom surface of the duct housing 100 through the guide 412. Accordingly, the driving link 400 remains fixed with respect to the first wing 200, which rotates vertically, and slides along the guide groove 103 in the left-right direction with the first wing 200 which moves in the left-right direction.

In addition, in a state in which the coupling hole 421 of the second body 420 is coupled to the coupling protrusion 320 of the second wing 300, the driving link 400 may slide with the first wing 200 to rotate the second wing 300 in the left-right direction.

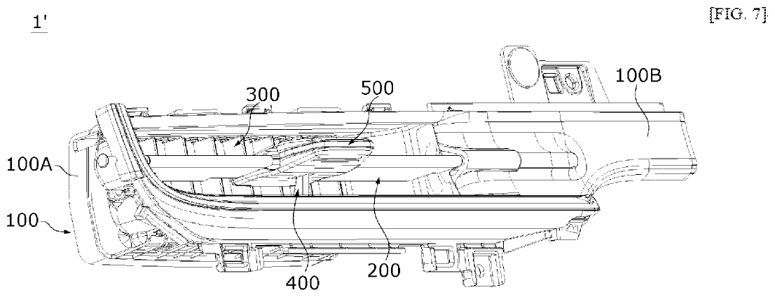

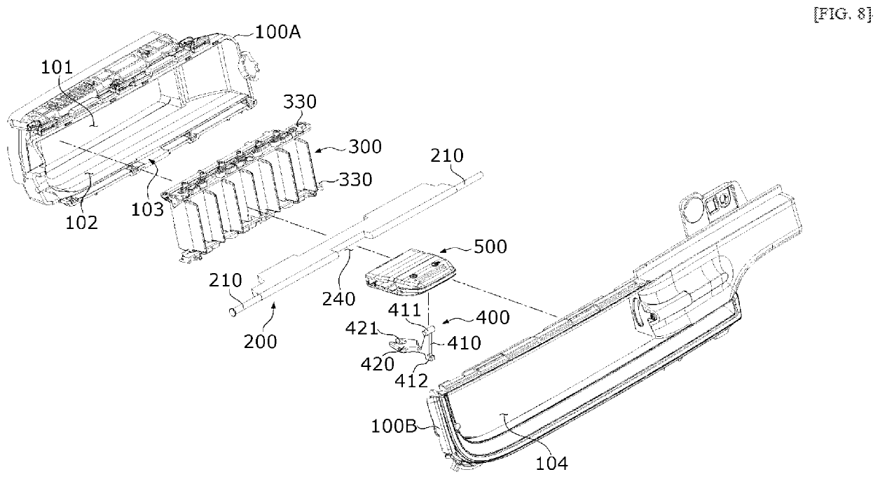

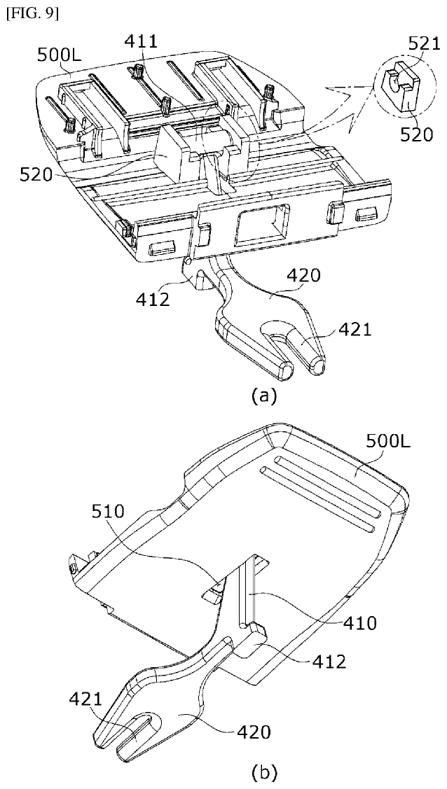

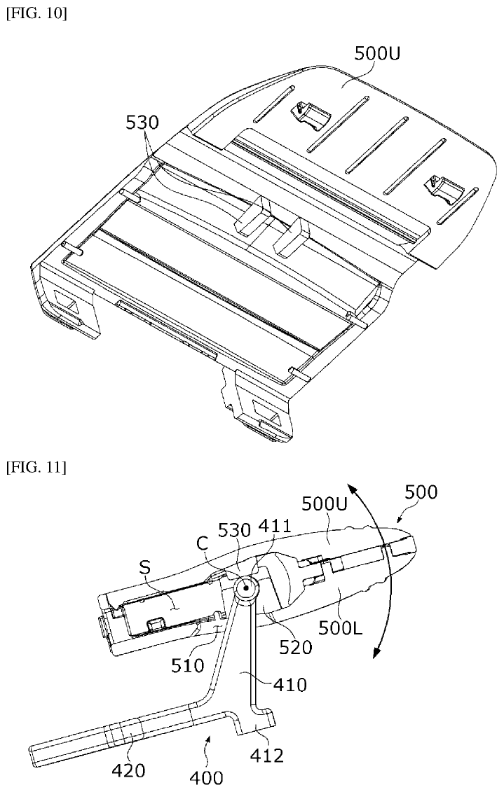

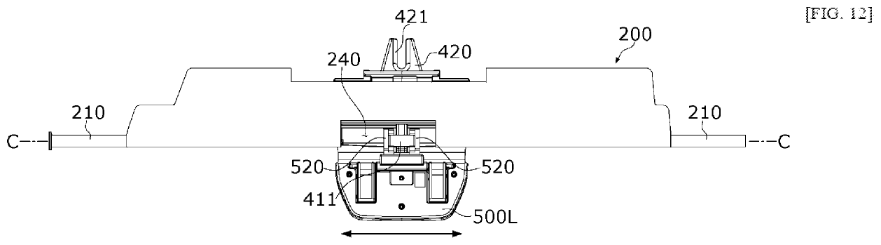

FIGS. 7 to 12 are views illustrating a vehicle air vent and a configuration thereof according to another embodiment of the present invention.

A vehicle air vent 1′ according to the embodiment illustrated in FIG. 7 differs from the jog-type vehicle air vent 1 in that the vehicle air vent 1′ described above is a knob-type vehicle air vent 1′ including a wing knob 500 coupled to a first wing 200. Hereinafter, differences therebetween will be described mainly.

Referring to the drawings, the vehicle air vent 1′ according to the embodiment of the present invention may include the wing knob 500 which is connected to the first wing 200 and rotates the first wing 200 in a vertical direction.

The wing knob 500 may be disposed in a discharge port 102 and provided to surround the first wing 200.

The wing knob 500 may include an upper knob 500U and a lower knob 500L which surround an upper portion and a lower portion of the first wing 200, respectively. In a state in which the upper knob 500U and the lower knob 500L are coupled to each other, the upper knob 500U and the lower knob 500L may have an inner space S of which both sides are open to allow the first wing 200 to pass through the inner space S.

The lower knob 500L may include a through hole 510 through which a first body 410 of a driving link 400 passes. In addition, the lower knob 500L may include a support 520 which protrudes from both sides of the through hole 510 and on which a connecting pin 411 is seated. A seating groove 521 to which the connecting pin 411 is rotatably fitted may be formed in the support 520.

Accordingly, in a state in which the first body 410 passes through the hole 510 and is inserted into the inner space S, as the connecting pin 411 on an upper end of the first body 410 is fitted to the seating groove 521 between a pair of supports 520, the driving link 400 may be rotatably connected thereto. In this case, the connecting pin 411 fitted to the seating groove 521 may be disposed along an axis C which is the same as that of a rotary shaft 210 of the first wing 200.

The upper knob 500U may include a pressing protrusion 530 protruding toward the support 520.

The pressing protrusion 530 may be provided as a pair of pressing protrusions 530 to correspond to the supports 520 and configured to press the connecting pin 411 in a state in which the upper knob 500U is coupled to the lower knob 500L. Accordingly, the connecting pin 411 can be prevented from being separated from the seating groove 521.

The first wing 200 may include an accommodation hole 240 in a portion coupled to the wing knob 500.

The accommodation hole 240 may be formed in the form to pass through the first wing 200 from the front of the first wing 200, cut in a longitudinal direction of the first wing 200, and configured to accommodate the support 520 in a state in which the first wing 200 is disposed in the inner space S of the wing knob 500.

The wing knob 500 may be coupled to the first wing 200 to slide along the accommodation hole 240 in a left-right direction. In addition, a movement range of the wing knob 500 in the left-right direction may be limited within a length range of the accommodation hole 240.

As described above, in the driving link 400, in a state in which the upper end of the first body 410 passes through the through hole 510, the upper end is rotatably disposed between and connected to the support 520 and the pressing protrusion 530 in the accommodation hole 240 of the first wing 200 through the connecting pin 411, and a lower end thereof is disposed in a discharge port 102 to be slidable in a guide groove 103 of a bottom surface of the duct housing 100 through a guide 412. Accordingly, the driving link 400 remains fixed even when the wing knob 500 vertically rotates with the first wing 200, and when the wing knob 500 moves along the first wing 200 in the left-right direction, the driving link 400 slides along the accommodation hole 240 and the guide groove 103 in the left-right direction with the wing knob 500.

In addition, in a state in which a coupling hole 421 of a second body 420 is coupled to a coupling protrusion 320 of a second wing 300, the driving link 400 may slide with the wing knob 500 to rotate the second wing 300 in the left-right direction.

As described above, according to the present embodiment, an effect of simplifying a shape of the second wing 300 to improve horizontal wind direction control performance and productivity is obtained.

In addition, in a state in which one side of the driving link 400 is connected to the first wing 200 and the other side thereof is connected to the second wing 300, as the first wing 200 rotates vertically and the second wing 300 rotates in the left-right direction using the driving link 400, an entire configuration can be simplified, and thus there is an effect of reducing costs.

In addition, as an ultra-slim air vent design can be implemented by adjusting a size of the driving link 400, there is an effect of improving a degree of design freedom.

According to an embodiment of the present invention, a vehicle air vent improved so that a structure and operating mechanism for controlling a wind direction can be simplified while a discharge port is slimmed can be provided.

Various embodiments of the present disclosure do not list all available combinations but are for describing a representative aspect of the present disclosure, and descriptions of various embodiments may be applied independently or may be applied through a combination of two or more.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A vehicle air vent comprising:
a duct housing;
a first wing horizontally extending in a discharge port of the duct housing;
a second wing vertically extending in the duct housing; and
a driving link of having a first side connected to the first wing and a second side connected to the second wing,
wherein the driving link is configured to slide along a guide groove in a bottom surface of the duct housing in the discharge port to rotate the second wing in a left-right direction.

2. The vehicle air vent of claim 1, wherein the driving link includes:
a first body extending from the first wing toward the bottom surface of the duct housing; and
a second body extending from the first body toward the second wing.

3. The vehicle air vent of claim 2, wherein
the first body includes a connecting pin extending horizontally along the first wing on an upper end of the first body and a guide protruding downward from a lower end of the first body, and
the driving link is configured to slide along the guide groove in a state in which the guide is inserted into the guide groove.

4. The vehicle air vent of claim 3, wherein the second body includes a coupling hole coupled to a coupling protrusion of the second wing in an end of the second body.

5. The vehicle air vent of claim 3, wherein
the first wing includes a connecting groove into which the connecting pin is rotatably connected, and
the connecting groove is connected to an opening that is open downward from the first wing along an inclined surface inclined downward toward the second wing.

6. The vehicle air vent of claim 5, further comprising a jog disposed outside the discharge port and coupled to the first wing to vertically rotate the first wing.

7. The vehicle air vent of claim 3, further comprising a wing knob disposed on the discharge port and connected to the first wing to vertically rotate the first wing,
wherein the wing knob includes an upper knob and a lower knob which surround the first wing, and
in state in which the upper knob and the lower knob are coupled to each other, the upper knob and the lower knob define an inner space of which both sides are open to allow the first wing to pass through the inner space.

8. The vehicle air vent of claim 7, wherein
the lower knob includes a through hole through which the first body passes and a support that protrudes from both sides of the through hole and in which the connecting pin is seated, and
a seating groove to which the connecting pin is rotatably fitted is disposed in the support.

9. The vehicle air vent of claim 8, wherein the upper knob includes a pressing protrusion that protrudes toward the support to prevent the connecting pin from being separated from the seating groove.

10. The vehicle air vent of claim 8, wherein the first wing includes an accommodation hole that accommodates the support in a state in which the first wing is disposed in the inner space.
